(19) United States
(12) Patent Application Publication
(10) Pub. No.: US 2005/0234832 A1
(43) Pub. Date: Oct. 20, 2005

(54) Recording/reproduction device for encrypting and recording data on storage medium and method thereof

(75) Inventor: Yuichi Kanai, Bisai (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/076,941

(22) Filed: Mar. 11, 2005

(30) Foreign Application Priority Data
Mar. 30, 2004 (JP) 2004-101496

(51) Int. Cl. G11B 5/58

(52) U.S. Cl. 705/57

(57) ABSTRACT

The present invention provides a recording/reproduction device which allows reproduction with a small delay. At the time of storing a program in a storage medium, the recording/reproduction device creates a contents key for encrypting the program data, encrypts the program data with the contents key, and stores the encrypted program data in the storage medium. Upon the user giving instructions for reproduction of the program which is being recorded, i.e., time-shift reproduction, the recording/reproduction device uses the same contents key already held for recording of the program. That is to say, the recording/reproduction device makes a copy of the license data including the contents key, reads out the encrypted program data from the storage medium, and decrypts the encrypted program data with the copy of the contents key, whereby the encrypted program data is reproduced. In this case, the step for reading out the contents key from the storage medium is omitted.

### BACKGROUND OF THE INVENTION

1. Field of the Invention

The present invention relates to a recording/reproduction technique, and particularly to a recording/reproduction device for encrypting contents data, and storing the contents data thus encrypted in a recording medium, and a method thereof.

2. Description of the Related Art

In recent years, handling of audio contents and video contents in the form of digital contents is becoming wide-spread. For example, terrestrial digital broadcasting has been introduced. Digital contents enable recording without deterioration in image quality or sound quality, thereby markedly improving ease-of-use for the user. However, such a technique which allows the user to make a copy without restriction leads to serious copyright infringement concerns. Accordingly, development of a device for recording/reproducing digital contents must be made giving sufficient consideration to copyright protection.

As a digital-contents reproduction technique developed giving consideration to copyright protection, a technique has been proposed wherein a decryption key of encrypted contents is encrypted based upon the public key cryptosystem for input/output (e.g., see International Publication WO 01-043339). Decryption of the data encrypted based upon the public key cryptosystem requires a considerable amount of calculation, meaning that a great amount of time is necessary for decryption. This leads to a delay from a request for reproduction made by the user up to the actual reproduction, resulting in a problem of poor ease-of-use for the user. Accordingly, the data-reproduction device disclosed in International Publication WO 01-043339 has an arrangement for performing authentication processing based upon the public key cryptosystem prior to reproduction, thereby realizing smooth reproduction.

While the data-reproduction device disclosed in International Publication WO 01-043339 has an arrangement wherein encrypted contents data is decrypted using a license key received from a single memory card at the time of reproduction, the present inventors have proposed a technique for reducing a delay at the time of reproduction in their development of a device having recording and reproducing functions.

### SUMMARY OF THE INVENTION

The present invention has been made in view of the above problems, and accordingly, it is an object thereof to provide a technique for reducing a delay at the time of reproduction, which is a problem of the recording/reproduction device having a function for encrypting the contents data for recording thereof.

An aspect of the present invention relates to a recording/reproduction device. The aforementioned recording/reproduction device comprises: a storage medium for storing encrypted contents data; and a cryptography processing unit for executing a series of cryptography input/output processing steps for encrypting a contents key used for decrypting the encrypted contents data, and performing input/output of the encrypted contents key between the recording/reproduction device and the storage medium, with the cryptography processing unit including a creating unit for creating the contents key at the time of recording the contents data on the storage medium, and holding the contents key thus created during recording of the contents data. With the aforementioned recording/reproduction device, upon making a request for reproduction of the contents data during recording of the same contents data, the encrypted contents data is decrypted using a contents key already held by the creating unit while omitting the cryptography input/output processing for reading out the contents key from the storage medium.

The cryptography input/output processing may include: device authentication processing based upon the public key cryptosystem; transmission/reception processing for a temporary encryption key for encrypting a contents key; transmission/reception processing for the encrypted contents key; and so forth. An encryption key created based upon the symmetric key cryptosystem may be employed as a contents key. In this case, the same key is employed as an encryption key for encrypting the contents data, and a decryption key for decrypting the encrypted contents data. According to the present invention, the contents key is encrypted with the cryptography input/output processing for input/output thereof, thereby preventing leakage thereof. On the other hand, at the time of reproduction of the contents data which is being recorded, the recording/reproduction device uses the same contents key already held for recording the program, so as to decrypt the encrypted contents data. This allows reproduction of the contents data while omitting the cryptography input/output processing which requires relatively long time, thereby reducing a delay from instructions for reproduction given by the user up to the actual reproduction.

The aforementioned storage medium may be mounted on a removable recording device detachably provided for the recording/reproduction device. With such a configuration, device authentication processing is preferably executed prior to input/output of the contents key between the recording/reproduction device and the removable storage device, for preventing an invalid device from reading out the contents key. The aforementioned device authentication processing requires relatively long time. Accordingly, at the time of reproduction of the contents data which is being recorded, the recording/reproduction device performs such reproduction while omitting the device authentication processing, thereby reducing a delay at the time of reproduction.

Another aspect of the present invention relates to a recording/reproduction method. The aforementioned recording/reproduction method comprises: a recording step for recording contents data on a storage medium; and a reproduction step for reproducing the contents data recorded on the storage medium, with the recording step including: a step for acquiring the contents data; a step for creating a contents key used for encrypting the contents data and decrypting the encrypted contents data; a step for encrypting the contents data with the contents key, and storing the encrypted contents data in the storage medium; and a step for encrypting the contents key, and storing the encrypted contents key in the storage medium with a series of cryptography input/output processing steps for input/output between the recording/reproduction device and the storage medium, and with the reproduction step including: a step for reading out the contents key from the storage medium with the cryptography input/output processing steps; a step for reading out the encrypted contents data from the storage medium; and a step for decrypting the encrypted contents data with the contents key. With the aforementioned recording/reproduction device, in a case of reproduction of contents data which is being recorded in the recording step, the step for reading out the contents key is omitted in the reproduction step, and the encrypted contents data is decrypted using a contents key which is being used in the recording step, in the decryption step.

Note that any combination of the aforementioned components or any manifestation of the present invention realized by modification of method, system, recording medium, computer program, and so forth, is effective as an embodiment of the present invention.

Moreover, this summary of the invention does not necessarily describe all necessary features so that the invention may also be sub-combination of these described features.

### BRIEF DESCRIPTION OF THE DRAWINGS

FIG. 1 is a diagram which shows a configuration of a recording/reproduction device according to an embodiment;

FIG. 2 is a diagram which shows a configuration of a removable HDD unit according to the embodiment;

FIG. 3 is a diagram which shows an example of an address structure of the storage area of the removable HDD unit;

FIG. 4 is a diagram which shows a directory/file structure for recording the program on the removable HDD unit;

FIG. 5 is a diagram which shows an example of the structure of a program management file;

FIG. 6 is a flowchart which shows the schematic operation of the recording/reproduction device for recording the program data on the removable HDD unit;

FIG. 7 is a flowchart which shows the schematic operation of the recording/reproduction device for reproducing the program data recorded on the removable HDD unit;

FIG. 8 is a diagram which shows a simple model of an example of authentication processing and license-data transmission processing for recording of the license data shown in FIG. 6;

FIG. 9 is a diagram which shows a simple model of an example of authentication processing and license-data transmission processing for readout of the license data shown in FIG. 7; and

FIG. 10 is a diagram which shows a procedure for time-shift reproduction according to the embodiment.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

### First Embodiment

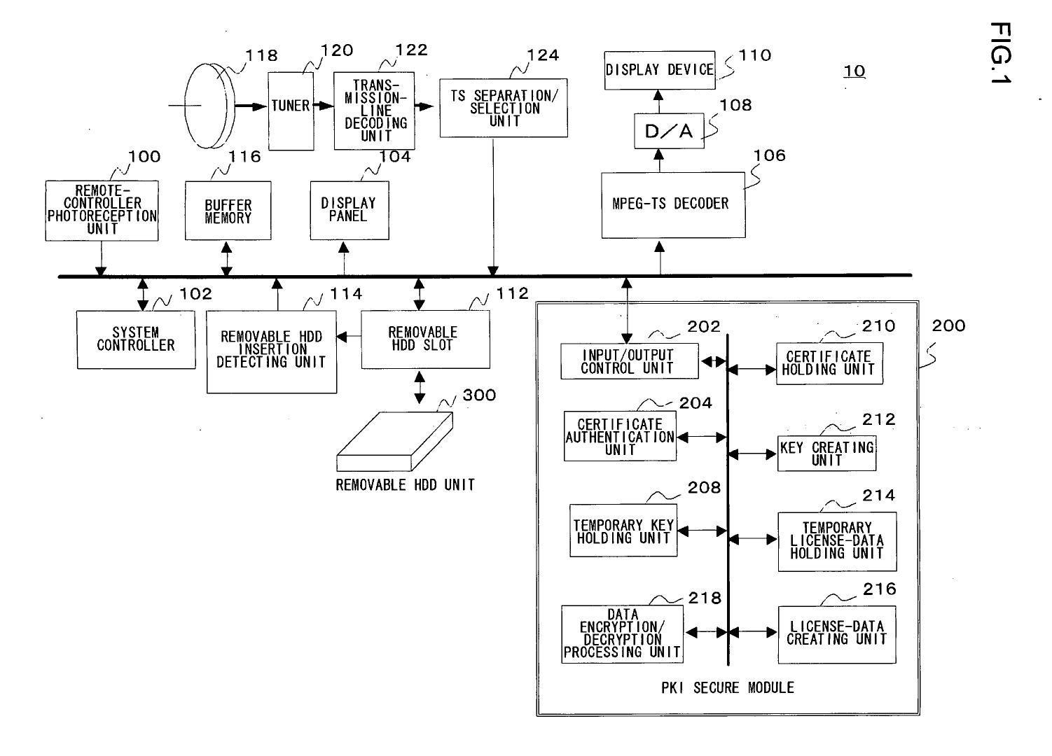

FIG. 1 shows a configuration of a recording/reproduction device 10 according to an embodiment. The recording/reproduction device 10 has functions serving as a receiving device for receiving digital broadcasting, a recording device for recording the program (contents) of the received digital broadcasting on a storage medium, and a reproduction device for reproducing the program recorded on the storage medium. With the present embodiment, a removable hard-disk drive (HDD) unit 300 removably mounted on the recording/reproduction device 10 is employed as a storage device including a storage medium, for example.

At the time of recording the video/audio data of the received program (which will be simply referred to as “program data” hereafter) on the removable HDD unit 300, the recording/reproduction device 10 according to the present embodiment encrypts the program data using an encryption key prior to recording thereof, for copyright protection. The key used for encrypting the program data will be referred to as “contents key” hereafter. While the program data may be encrypted based upon any desired cryptosystem, description will be made in the present embodiment regarding an arrangement wherein the program data is encrypted based upon the symmetric key cryptosystem. With such a configuration, both the encryption and decryption of the program data are performed using the same key. The encryption of the program data has a low risk of being broken even in a case of data leakage, and accordingly, the encrypted program data is input/output according to ordinary read/write commands. On the other hand, the contents key required for reproducing the program data is highly secret data which requires security against leakage thereof, and accordingly, the contents key is input/output according to a special input/output protocol which gives high priority to security thereof (which will be referred to as “secure protocol” hereafter). With the present embodiment, a secure protocol based upon the public key cryptosystem is employed, and the program is recorded on a removable storage medium; accordingly, such an arrangement requires device-authentication processing prior to recording of the program, or reproducing thereof. With the secure protocol according to the present embodiment, authentication processing is performed using a device certificate. Upon confirmation of the validity of the certificate, the recording/reproduction device 10 establishes a session for transmission/reception of confidential data (which will be referred to as “secure session” hereafter).

At the time of reproducing the program data recorded on the removable HDD unit 300, the recording/reproduction device 10 needs to read out the contents key from the removable HDD unit 300 using the secure protocol. However, public key cryptosystem requires a relatively long time for decryption processing due to a large amount of calculation. Accordingly, an arrangement wherein the contents key is read out according to user instructions for reproduction leads to a delay of actual reproduction from the point in time that the user has made instructions for reproduction, resulting in a slower response than the user anticipates.

The recording/reproduction device 10 according to the present embodiment has a function which allows reproduction and recording of the program at the same time, i.e., so-called “time-shift function”. While conventional recording devices allow the user to reproduce the program only after recording of the program, the recording/reproduction device 10 according to the present embodiment allows the user to reproduce the program while recording the same program according to a request for time-shift reproduction made by the user, due to a hard disk employed as a recording medium. At the time of the user making a request for time-shift reproduction, the recording/reproduction device 10 is recording the program. Accordingly, the recording/reproduction device 10 has a contents key for encrypting the program data in this stage. With the present embodiment, upon the user making a request for time-shift reproduction, the recording/reproduction device 10 does not acquire the contents key from the removable HDD unit 300, but uses the contents key already held in this stage. This allows reproduction without acquisition of the contents key using a secure protocol which requires long time, thereby suppressing a delay from a request for reproduction made by the user up to the actual reproduction.

The recording/reproduction device 10 includes a remote-controller photoreception unit 100, a system controller 102, a display panel 104, an MPEG-TS decoder 106, a D/A converter 108, a display device 110, a removal HDD slot 112, a removal HDD insertion detecting unit 114, buffer memory 116, an antenna 118, a tuner 120, a transmission-line decoding unit 122, a TS separation/selection unit 124, a PKI secure module 200 which is an example of a cryptography processing unit.

The remote-controller photoreception unit 100 receives the light emitted from a remote controller (not shown) which allows the user to input instructions to the recording/reproduction device 10, thereby acquiring the instructions from the user. The system controller 102 controls each component of the recording/reproduction device 10. The display panel 104 displays various kinds of control information. The MPEG-TS decoder 106 decodes MPEG-TS signals. The D/A converter 108 converts digital signals into analog signals. The display device 110 displays the program data which has been decoded and converted into analog signals.

The removable HDD slot 112 allows the user to connect the removable HDD unit 300 which is a storage device for storing the program data, to the recording/reproduction device 10. The removal HDD insertion detecting unit 114 detects whether the removable HDD unit 300 has been attached/detached to/from the removable HDD slot 112. The buffer memory 116 has functions serving as a storage area for storing data necessary for the operation of the recording/reproduction device 10, e.g., for temporarily storing MPEG/TS signals which have been separated and selected by the TS separation/selection unit 124.

The antenna 118 receives broadcasting signals subjected to digital conversion. The tuner 120 extracts the signals of the channel selected by the user, from the broadcasting signals received with the antenna 118, according to instructions from the system controller 102. The transmission-line decoding unit 122 decodes the signals extracted by the tuner 120, in the format of video/audio data coded in the MPEG2, and outputs the decoded data to the TS separation/selection unit 124. In the event that the program data is not stored in the removable HDD unit 300, the TS separation/selection unit 124 outputs MPEG transport stream signals to the MPEG-TS decoder 106. The MPEG-TS decoder 106 decodes the MPEG TS signals separated by the TS separation/selection unit 124. The D/A converter 108 converts the digital signals decoded by the MPEG-TS decoder 106, in the form of analog signals. The display device 110 displays the program data in the form of analog signals converted by the D/A converter 108. The PKI secure module 200 controls communication between the recording/reproduction device 10 and the removable HDD unit 300 using the secure protocol.

The PKI secure module 200 includes an input/output control unit 202, a certificate authentication unit 204, a temporary key holding unit 208, a certification holding unit 210, a key creating unit 212, a temporary license-data holding unit 214, a license-data creating unit 216, and a data encryption/decryption processing unit 218. Part or all of the aforementioned components may be realized by hardware means, e.g., by actions of a CPU, memory, and other LSIs, of a computer, and by software means, e.g., by actions of a program or the like, loaded to the memory. Here, the drawing shows a functional block configuration which is realized by cooperation of the hardware components and software components. It is needless to say that such a functional block configuration can be realized by hardware components alone, software components alone, or various combinations thereof, which can be readily conceived by those skilled in this art.

The input/output control unit 202 controls input/output of data between each component within the PKI secure module and an external component. The PKI secure module 200 stores confidential information such as a contents key, license data, and so forth, and accordingly, has a configuration which protects such confidential information from direct access from an external device, thereby preventing leakage of the confidential information. The certificate authentication unit 204 authenticates the validity of the certificate transmitted from the removable HDD unit 300. The temporary key holding unit 208 temporarily holds a key used in the secure session. The certificate holding unit 210 holds the certificate of the recording/reproduction device 10. The aforementioned certificate has been authenticated by an authentication authority, and includes an embedded public key of the recording/reproduction device 10. Note that the certificate is encrypted by the secret key of the authentication authority. The key creating unit 212 creates a key used in the secure session. The temporary license-data holding unit 214 temporarily holds the license data of the program received from the removable HDD unit 300 at the time of reproducing the program recorded on the removable HDD unit 300. The license-data creating unit 216 creates license data including the contents key and license information at the time of recording the program on the removable HDD unit 300. The data encryption/decryption processing unit 218 performs encryption processing for the data, and decryption processing for encrypted data.

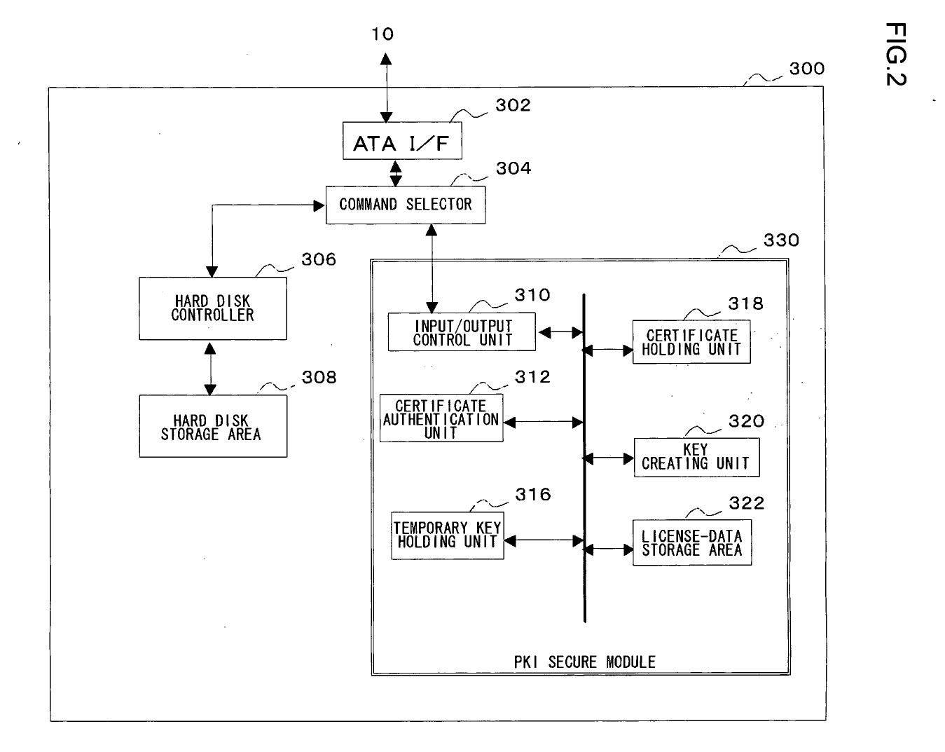

FIG. 2 shows a configuration of the removable HDD unit 300 including a built-in PKI secure module. The removable HDD unit 300 includes a built-in PKI secure module 330 for handling cryptography input/output processing using the PKI method. The removable HDD unit 300 includes an ATA interface 302, a command selector 304, a hard disk controller 306, a hard disk storage area 308, and the PKI secure module 330. Such a configuration may be realized in various forms, e.g., by hardware means alone, by software means alone, or by a combination thereof.

The ATA interface 302 accepts the command stipulated by the ATA (AT attachment) which is the standard of the ANSI (American National Standards Institute). Upon reception of the command issued by the recording/reproduction device 10, the command selector 304 determines whether the received command is an ordinary command or a secure-protocol command. In a case of an ordinary command, the command selector 304 transmits the command to the hard disk controller 306. On the other hand, in a case of a secure-protocol command, the command selector 304 transmits the command to the PKI secure module 330. Upon reception of the ordinary input/output command, the hard disk controller 306 writes/reads the data to/from the hard disk storage area 308. The PKI secure module 330 controls communication between the removable HDD unit 300 and the recording/reproduction device 10 using the secure protocol.

The PKI secure module 330 includes an input/output control unit 310, a certificate authentication unit 312, a temporary key holding unit 316, a certificate holding unit 318, a key creating unit 320, and a license-data storage area 322. The input/output control unit 310 controls input/output between each component within the PKI secure module 330 and an external component. The PKI secure module 330 stores confidential information such as the contents key of the contents, the license data, and so forth, and accordingly, has a configuration which protects such confidential information from direct access from an external device, thereby preventing leakage of the confidential information. The certificate authentication unit 312 authenticates the validity of the certificate transmitted from the recording/reproduction device 10. The temporary key holding unit 316 temporarily holds a key used in the secure session. The certificate holding unit 318 holds the certificate of the removable HDD unit 300. The certificate has been authenticated by the authentication authority, and includes an embedded public key of the removable HDD unit 300. Note that the certificate is encrypted with the secret key of the authentication authority. The key creating unit 320 creates a key used for the secure session. The license-data storage area 322 stores the license data including the contents key for reproducing the program recorded in the removable HDD unit 300.

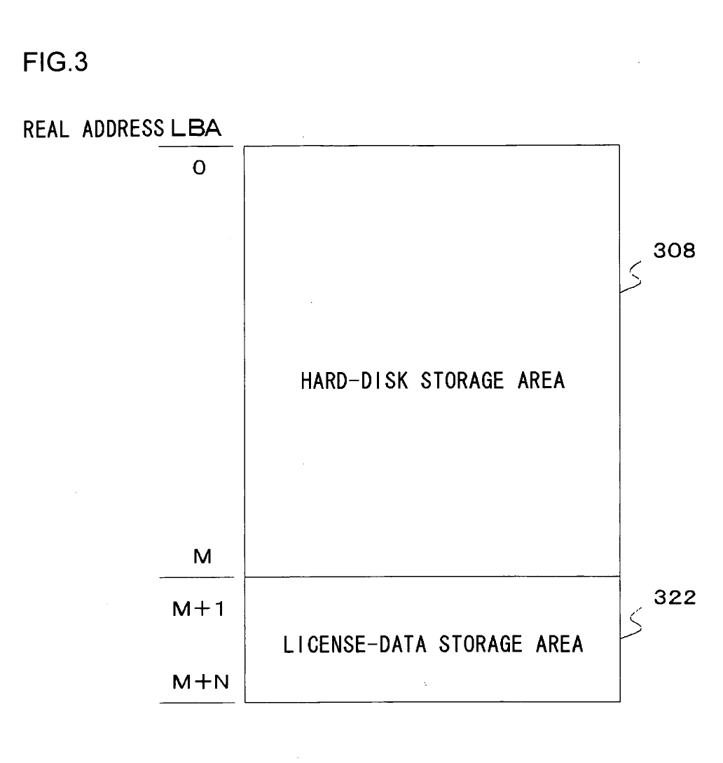

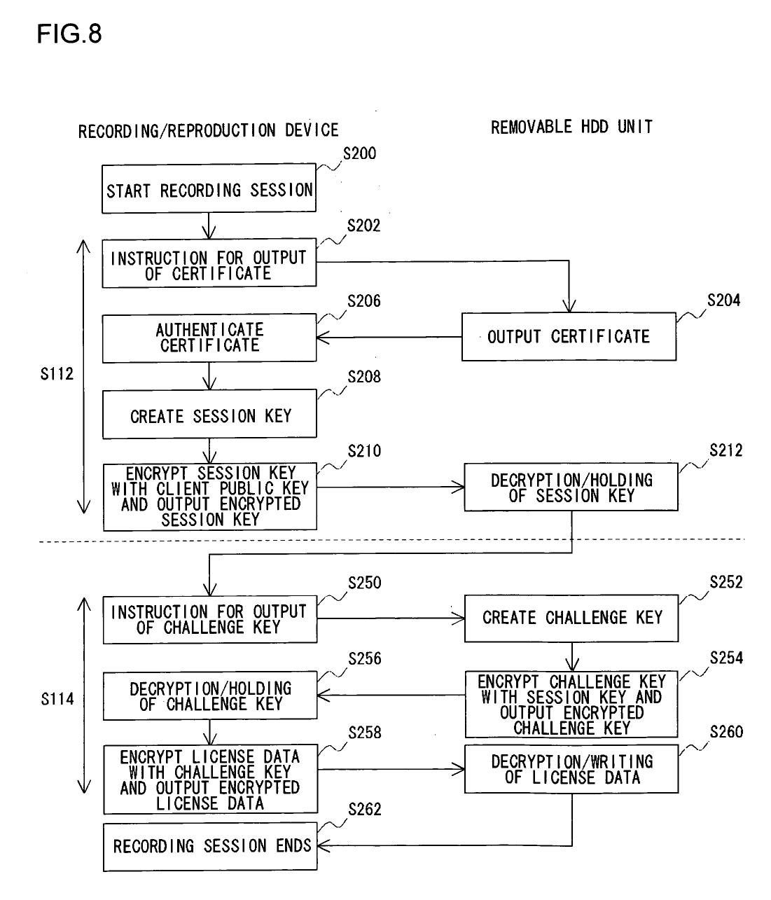

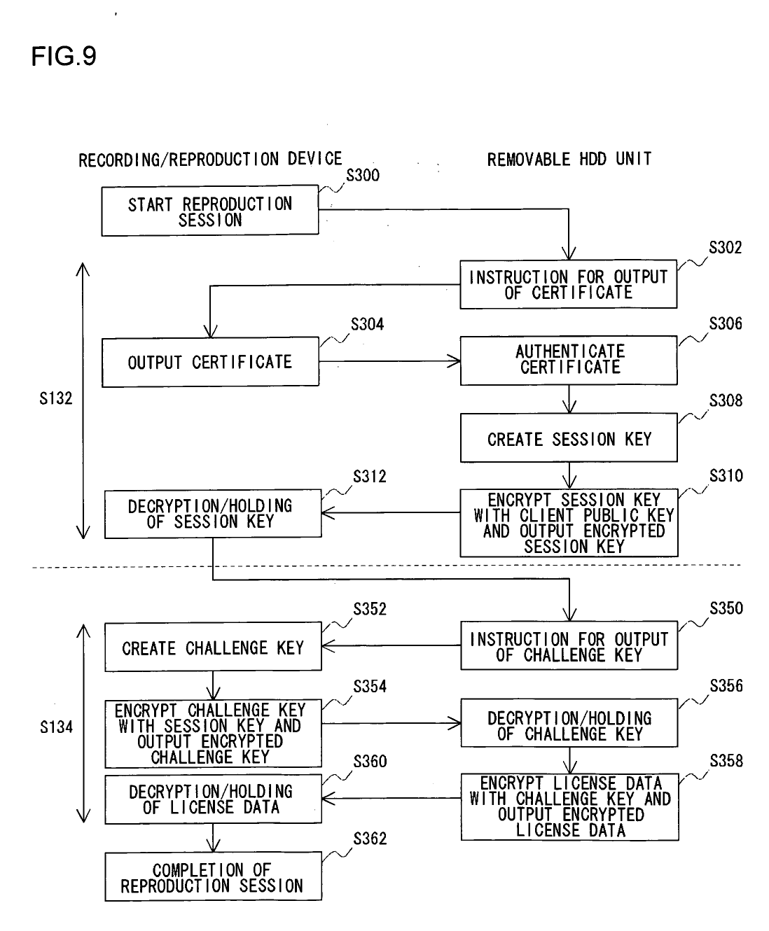

FIG. 3 shows an example of an address structure of the storage area of the removable HDD unit 300. In general, the address of the hard disk is represented by an LBA (Logical Block Address). In an example shown in FIG. 3, the storage area at lower LBAs (0 through M) corresponds to the hard disk storage area 308 shown in FIG. 2. The storage area allows access using ordinary Read/Write commands. On the other hand, the storage area at higher LBAs (M+1 through M+N) corresponds to the license-data storage area 322 shown in FIG. 2. This storage area allows limited access only using special command procedure shown in FIGS. 8 and 9.

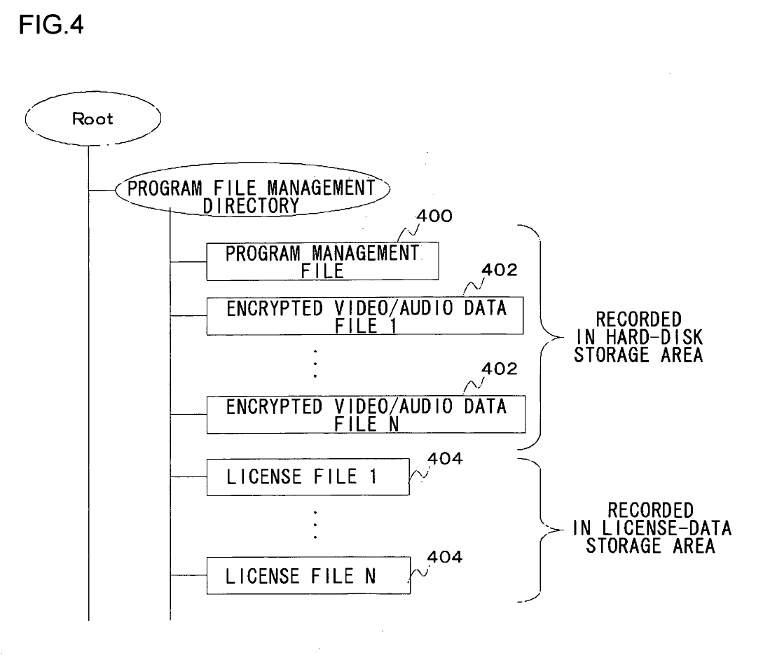

FIG. 4 shows a directory/file configuration of an arrangement wherein the program is recorded on the removable HDD unit 300. The entire information regarding the recorded program is managed under a program file management directory. A program management file 400 is a file for storing the data for managing the recorded programs. An encrypted video/audio data file 402 is a file for storing the data of the program in the format of the encrypted MPEG-TS signal. A license file 404 is a file for storing the license information such as conditions for use of the program and so forth, and license data including the contents key for decrypting the encrypted program data, which is provided for each recorded program. The program management file 400 and the encrypted video/audio data files 402 are recorded in the hard disk storage area 308 shown in FIGS. 2 and 3. On the other hand, the license files 404 are stored in the license-data storage area 322. The data of the program is encrypted for input/output, and accordingly, has a low risk of leakage even in a case wherein the data is recorded in the hard disk storage area 308 using the ordinary read/write commands. Accordingly, with the present embodiment, only the license data is recorded in the license-data storage area 322 using the secure protocol. This enables high-speed read/write of the program data while maintaining sufficient security of the license data.

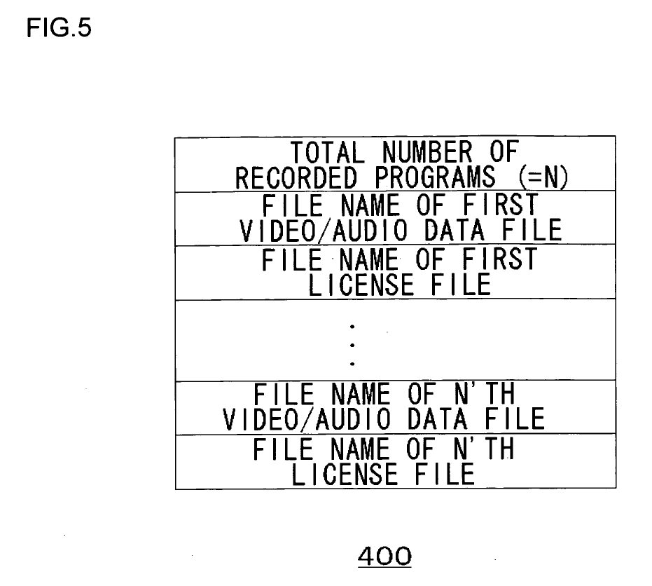

FIG. 5 shows an example of the structure of the program management file 400. The program management file 400 is a file for recording the management information regarding all the programs recorded on the removable HDD unit 300. First, the number of all the recorded programs is recorded in the program management file 400. Here, the number of all the recorded programs will be represented by N. Subsequently, N combinations of the file name of the encrypted data file and the file name of the corresponding license file are recorded in the program management file 400. This file structure allows the user to perform high-speed and effective file search for the program recorded on the hard disk. Furthermore, this file is used for management of the combinations of the encrypted data and the license, as well.

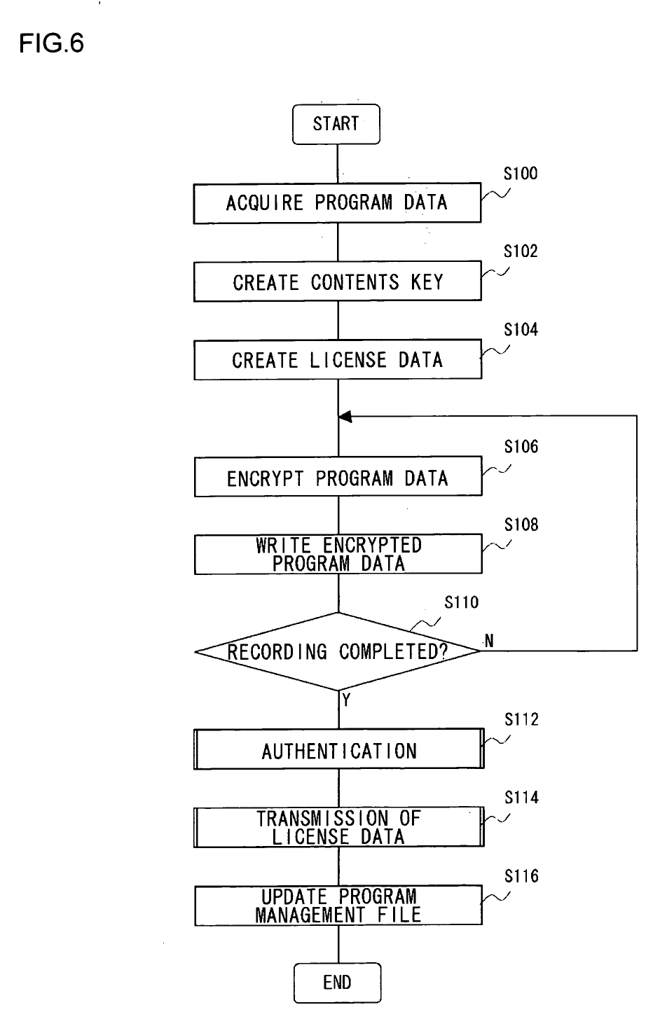

FIG. 6 is a flowchart which shows a schematic operation of the recording/reproduction device 10 at the time of recording the program data on the removable HDD unit 300. First, the recording/reproduction device 10 acquires the program data from the digital broadcasting waves (S100). Specifically, the tuner 120 extracts the data of the channel selected by the user, from the broadcasting signals received with the antenna 118. Then, the transmission-line decoding unit 122 decodes the data, and the TS separation/selection unit 124 extracts the MPEG-TS signal, whereby the MPEG-TS signal is transmitted to the PKI secure module 200. The program transmitted to the PKI secure module 200 is transmitted to the data encryption/decryption processing unit 218 through the input/output control unit 202. The license-data creating unit 216 creates the contents key for encrypting the program data (S102). Furthermore, the license-data creating unit 216 extracts the license information such as the conditions for use, from the MPEG-TS signal, so as to create the license data of the program (S104). Let us say that the information regarding the conditions for use includes a digital-copy control descriptor (copy control information), a contents availability descriptor (temporary accumulation information), a parental rating descriptor (age-restriction information), and so forth. The license data includes the license information and the contents key.

The data encryption/decryption processing unit 218 encrypts the program data with the contents key (S106). The encrypted program data is transmitted to the removable HDD unit 300 through the input/output control unit 202 and the removable HDD slot 112. In the removable HDD unit 300, the encrypted program data is recorded in the hard disk storage area 308 through the ATA interface 302, the command selector 304, and the hard disk controller 306 (S108). During recording of the program (in a case of “No” in S110), the procedure for encrypting the program data (S106) and the procedure for writing the program data (S108) are repeated. Upon completion of the recording (in a case of “Yes” in Step S110), the recording/reproduction device 10 authenticates the removable HDD unit 300 (S112). In a case wherein determination has been made that the removable HDD unit 300 is valid, the recording/reproduction device 10 transmits the license data to the removable HDD unit 300 so as to be recorded on the removable HDD unit 300 (S114). Note that authentication of the removable HDD unit 300 and transmission of the license data are performed using the secure protocol based upon the public key cryptosystem. Detailed description will be made later regarding the authentication processing (S112) and the transmission processing for the license data (S114)

Finally, the application program updates the program management file 400 for managing the combinations of the encrypted program data and the license data (S116). An arrangement may be made wherein the recording/reproduction device 10 reads out and updates the program management file 400, following which the recording/reproduction device 10 rewrites the updated program management file 400 to the removable HDD unit 300. Furthermore, an arrangement may be made wherein the recording/reproduction device 10 transmits a command to the hard disk controller 306 or the like, so as to update the program management file 400.

While description has been made regarding an arrangement wherein the PKI secure module 200 of the recording/reproduction device 10 transmits the license data to the PKI secure module 330 of the removable HDD unit 300 following recording of the program data with reference to the drawing, the present invention is not restricted to such an arrangement wherein transmission of the license data is performed following recording of the program. Rather, an arrangement may be made wherein, following creation of the license data in S104, transmission of the license data is performed while transmitting the encrypted program data. Furthermore, an arrangement may be made wherein transmission of the encrypted program data is started following transmission of the license data. In this case, the encrypted program data is stored in the buffer memory 116 during transmission of the license data.

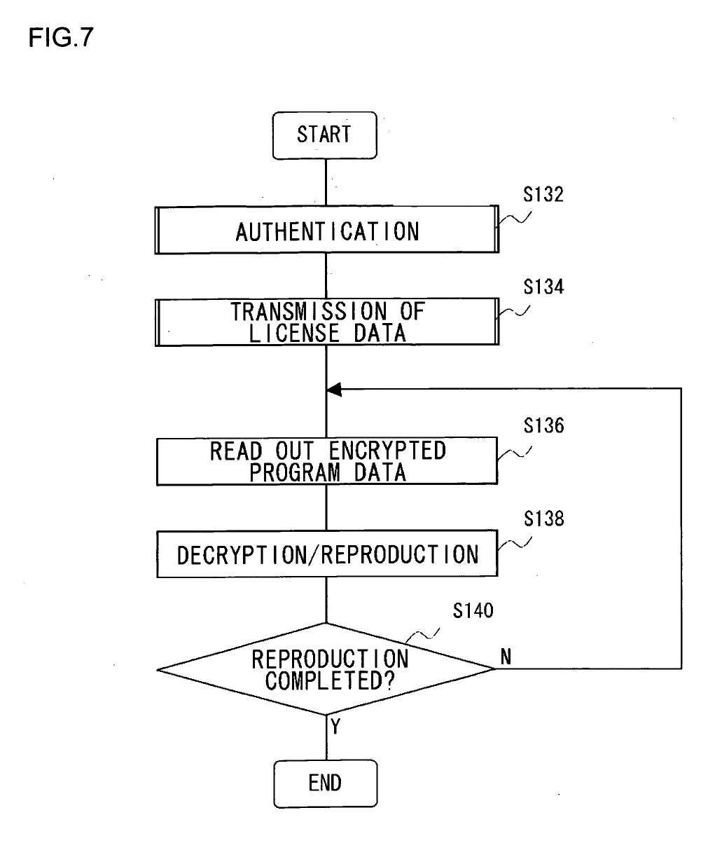

FIG. 7 is a flowchart which shows schematic operation of the recording/reproduction device 10 at the time of reproducing the program data recorded on the removable HDD unit 300. Note that FIG. 7 shows the procedure for handling an ordinary reproduction request, and description will be made later regarding time-shift reproduction. First, the removable HDD unit 300 authenticates the recording/reproduction device 10 (S132) in order to read out the license data corresponding to the program which is to be reproduced. Upon successful authentication of the recording/reproduction device 10, the license data recorded in the license-data storage area 322 of the removable HDD unit 300 is transmitted to the PKI secure module 200 of the recording/reproduction device 10 (S134). Note that authentication of the recording/reproduction device 10 and transmission of the license data are performed using the secure protocol based upon the public key cryptosystem. Detailed description will be made later regarding the authentication processing (S132) and transmission processing for the license data (S134). The transmitted license data is temporarily held by the temporary license-data holding unit 214.

Next, the encrypted program data is read out from the hard disk storage area 308, and is transmitted to the recording/reproduction device 10 (S136). The data encryption/decryption processing unit 218 of the recording/reproduction device 10 decrypts the encrypted program data using the contents key included in the license data held by the temporary license-data holding unit 214. The decrypted program data is output to the display device 110 through the MPEG-TS decoder 106 and the D/A converter 108, whereby reproduction of the program data is performed (S138). During reproduction of the program (in a case of “No” in S140), the procedure for readout of the encrypted program data (S136) and the procedure for decryption/reproduction (S138) are repeated. Upon completion of reproduction of the program, or upon the user instructing the end of reproduction (in a case of “Yes” in S140), the processing ends.

FIG. 8 shows an example of a simple model of the authentication processing and transmission processing for the license data for recording of the license data shown in FIG. 6. The secure session for recording of the program shown in the drawing will be referred to as “recording session” hereafter. With the present embodiment, the recording session is executed using the secure protocol based upon the public key cryptosystem. Details of the PKI protocol is disclosed in Japanese Unexamined Patent Application Publication No. 2003-248557, for example. While in reality, commands and data are exchanged between: the controller and the PKI secure module 200 of the recording/reproduction device 10; and the controller and the PKI secure module 330 of the removable HDD unit 300; description will be made below with reference to the drawing regarding a simple model wherein the commands and data are exchanged between the recording/reproduction device 10 and the removable HDD unit 300.

First, detailed description will be made regarding the procedure wherein the recording/reproduction device 10 authenticates the removable HDD unit 300 so as to establish the recording session (S112). Upon start of the recording session for recording the license data on the removable HDD unit 300 (S200), first, the recording/reproduction device 10 makes a request to the removable HDD unit 300 for output of a certificate (S202). The removable HDD unit 300 outputs the certificate stored in the certificate holding unit 318 according to the aforementioned request (S204). The certificate authentication unit 204 of the recording/reproduction device 10 decrypts the encrypted certificate thus received, using the public key of the authentication authority embedded in the PKI secure module 200, whereby the validity of the certificate is checked (S206). Upon confirmation of the validity of the certificate, the key creating unit 212 creates a session key (S208), encrypts the session key using the public key of the removable HDD unit 300 embedded in the certificate, and outputs the encrypted session key (S210), as well as holding the session key in the temporary holding unit 208. The session key serves as a symmetric key temporarily valid in the recording session. The temporary key holding unit 316 of the removable HDD unit 300 decrypts the encrypted session key thus received, using the secret key of the removable HDD unit 300, and holds the session key (S212). At this point, the recording/reproduction device 10 and the removable HDD unit 300 share the session key.

Next, detailed description will be made regarding the procedure for transmission of the license data to the removable HDD unit 300 performed by the recording/reproduction device 10 (S114). The recording/reproduction device 10 makes a request to the removable HDD unit 300 for output of a challenge key (S250). The key creating unit 320 of the removable HDD unit 300 creates a challenge key according to the aforementioned request (S252). The removable HDD unit 300 encrypts the challenge key with the session key held by the temporary key holding unit 316 and outputs the challenge key thus encrypted (S254) while holding the challenge key in the temporary key holding unit 316. The temporary key holding unit 208 of the recording/reproduction device 10 decrypts the encrypted challenge key thus received, using the session key held by the temporary key holding unit 208, and holds the challenge key thus decrypted (S256). Next, the recording/reproduction device 10 reads out the license data which is to be transmitted to the removable HDD unit 300, from the temporary license-data holding unit 214, encrypts the license data with the challenge key, and outputs the encrypted license data (S258). The removable HDD unit 300 decrypts the encrypted license data thus received at the license-data storage area 322 thereof, using the challenge key held by the temporary key holding unit 316 (S260). Following the aforementioned procedure, this series of recording sessions ends (S262).

FIG. 9 shows an example of a simple model of the authentication processing and the license-data transmission processing for readout of the license data shown in FIG. 7. The secure session for reproduction shown in the drawing will be referred to as “reproduction session” hereafter. With the present embodiment, the reproduction session is executed using a secure protocol based upon the public key cryptosystem. Now, description will be made in the present embodiment regarding a simple model of the reproduction session wherein information is exchanged between the recording/reproduction device 10 and the removable HDD unit 300. The procedure for the reproduction session has the same structure as with the procedure for the recording session shown in FIG. 8 wherein the recording/reproduction device 10 and the removable HDD unit 300 are exchanged.

First, detailed description will be made regarding the procedure wherein the removable HDD unit 300 authenticates the recording/reproduction device 10 so as to establish the reproduction session (S132). Upon start of the reproduction session for readout of the license data from the removable HDD unit 300 (S300), first, the removable HDD unit 300 makes a request to the recording/reproduction device 10 for output of a certificate (S302). The recording/reproduction device 10 outputs the certificate stored in the certificate holding unit 210 according to the aforementioned request (S304). The certificate authentication unit 312 of the removable HDD unit 300 decrypts the encrypted certificate thus received, using the public key of the authentication authority embedded in the PKI secure module 330 so as to check the validity of the certificate (S306). In a case wherein the certificate is valid, the key creating unit 320 creates a session key (S308), and stores the session key in the temporary key holding unit 316. At the same time, the session key is encrypted with the public key of the recording/reproduction device 10 embedded in the certificate, and is output (S310). The session key serves as a symmetric key temporarily valid for the reproduction session. The temporary key holding unit 208 of the recording/reproduction device 10 decrypts the encrypted session key thus received, using the secret key of the recording/reproduction device 10, and holds the session key (S312). At this point, the removable HDD unit 300 and the recording/reproduction device 10 share the session key.

Next, detailed description will be made regarding the procedure for transmission of the license data to the recording/reproduction device 10 performed by the removable HDD unit 300 (S134). The removable HDD unit 300 makes a request to the recording/reproduction device 10 for output of a challenge key (S350). The key creating unit 212 of the recording/reproduction device 10 creates a challenge key according to the aforementioned request (S352). The recording/reproduction device 10 encrypts the challenge key with the session key held by the temporary key holding unit 208 and outputs the challenge key thus encrypted (S354) while holding the challenge key in the temporary key holding unit 208. The temporary key holding unit 316 of the removable HDD unit 300 decrypts the encrypted challenge key thus received, using the session key held by the temporary key holding unit 316, and holds the challenge key thus decrypted (S356). Next, the removable HDD unit 300 reads out the license data which is to be transmitted to the recording/reproduction device 10, from the license-data storage area 322, encrypts the license data with the challenge key, and outputs the encrypted license data (S358). The temporary license-data holding unit 214 of the recording/reproduction device 10 decrypts the encrypted license data thus received, using the challenge key held by the temporary key holding unit 208 (S360). Following the aforementioned procedure, this series of reproduction sessions ends (S362).

While the procedure for transmission/reception of the license data shown in FIGS. 8 and 9 exhibits high security, such procedure requires a great amount of calculation due to high security, leading to long processing time. That is to say, in some cases, such a reproduction procedure for the program shown in FIG. 7 leads to a problem of a time lag from the user instructions for reproduction of the program up to display of the program on the display device 110, resulting in poor ease-of-use for the user. With the present embodiment, time-shift reproduction, i.e., reproduction of the program while recording of the same program, is performed using the license data already held by the recording/reproduction device 10 while omitting authentication and transmission of the license data. This reduces a delay from a request for time-shift reproduction made by the user up to the actual reproduction.

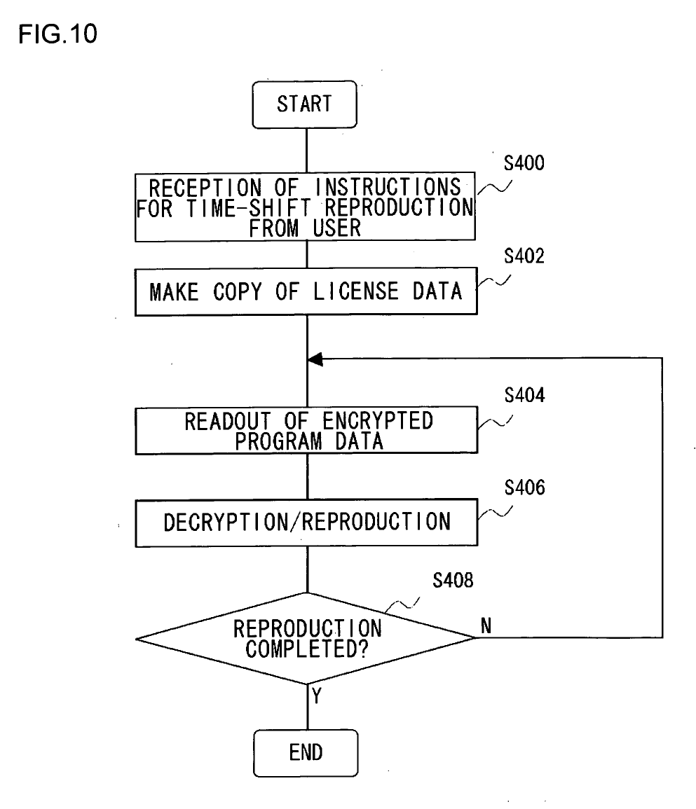

FIG. 10 is a flowchart which shows a procedure for time-shift reproduction. Upon the user giving instructions for reproduction of the program which is being recorded, i.e., time-shift reproduction (S400), the system controller 102 makes a copy of the license data of the program which is being recorded, held by the license-data creating unit 216, and the copy thus created is transmitted to the license-data holding unit 214 (S402). With the present embodiment, the authentication step (S132) and the license-data transmission step (S134) of the ordinary reproduction procedure shown in FIG. 7 are omitted.

Thereafter, the same procedure is performed as that shown in FIG. 7, wherein the encrypted program data is read out from the hard disk storage region 308, and is transmitted to the recording/reproduction device 10 (S404). The recording/reproduction device 10 decrypts the encrypted program data at the data encryption/decryption processing unit 218 using a contents key included in the license data held by the temporary license-data holding unit 214, whereby the encrypted program data is decrypted. The decrypted program data is output to the display device 110 through the MPEG-TS decoder 106 and the D/A converter 108, whereby the program data is reproduced (S406). Note that the step for reading out the encrypted program data (S404) and the step for decryption/reproduction (S406) are repeated during reproduction. Upon completion of reproduction of the program, or upon the user giving instructions for the end of reproduction (in a case of “YES” in S408), the processing ends.

As described above, description has been made regarding the present invention with reference to the aforementioned embodiments. The above-described embodiments have been described for exemplary purposes only, and are by no means intended to be interpreted restrictively. Rather, it can be readily conceived by those skilled in this art that various modifications may be made by making various combinations of the aforementioned components or the aforementioned processing, which are also encompassed in the technical scope of the present invention.

While description has been made in the aforementioned embodiments regarding an arrangement wherein the removable HDD unit 300 is employed as a storage medium, an arrangement may be made wherein the storage medium is built into the recording/reproduction device 10. Note that the removable HDD unit 300 according to the aforementioned embodiment may be packaged with the recording/reproduction device 10 at the time of shipping. Also, the user may purchase the removable HDD unit 300 from a vendor or the like, separately from the recording/reproduction device 10.

1. A recording/reproduction device comprising:
a storage medium for storing encrypted contents data; and
a cryptography processing unit for executing a series of cryptography input/output processing steps for encrypting a contents key used for decrypting said encrypted contents data, and performing input/output of said encrypted contents key between said recording/reproduction device and said storage medium,
wherein said cryptography processing unit includes a creating unit for creating said contents key at the time of recording said contents data on said storage medium, and holding said contents key thus created during recording of said contents data,
and wherein, upon making a request for reproduction of said contents data during recording of said contents data, said encrypted contents data is decrypted using a contents key held by said creating unit while omitting said cryptography input/output processing for reading out said contents key from said storage medium.

2. A recording/reproduction device according to claim 1, wherein said storage medium is mounted on a storage device removably provided for said recording/reproduction device.

3. A recording/reproduction method comprising:
recording contents data on a storage medium; and
reproducing said contents data recorded on said storage medium,
wherein said recording includes:
acquiring said contents data;
creating a contents key used for encrypting said contents data and decrypting said encrypted contents data;
encrypting said contents data with said contents key, and storing said encrypted contents data in said storage medium; and
encrypting said contents key, and storing said encrypted contents key in said storage medium with a series of cryptography input/output processing steps for input/output between said recording/reproduction device and said storage medium,
and wherein said reproducing includes:
reading out said contents key from said storage medium with said cryptography input/output processing steps;
reading out said encrypted contents data from said storage medium; and
decrypting said encrypted contents data with said contents key,
and wherein in a case of reproduction of contents data which is being recorded in said recording, said reading out said contents key is omitted in said reproducing, and said encrypted contents data is decrypted using a contents key which is being used in said recording, in said decrypting step.

4. A recording/reproduction device including an cryptography processing unit for executing a series of cryptography input/output processing steps for encrypting a contents key used for decrypting encrypted contents data, and performing input/output of said encrypted contents key between said recording/reproduction device and a storage medium for storing said encrypted contents data, wherein said cryptography processing unit includes a creating unit for creating said contents key at the time of recording said contents data on said storage medium, and for holding said contents key thus created during recording of said contents data,
and wherein, upon making a request for reproduction of said contents data during recording of said contents data, said encrypted contents data is decrypted using a contents key already held by said creating unit while omitting said cryptography input/output processing steps for reading out said contents key from said storage medium.

5. A recording/reproduction device according to claim 4, wherein said storage medium is mounted on a storage device removably provided for said recording/reproduction device.
